(19) United States
(12) Patent Application Publication
(10) Pub. No.: US 2015/0372844 A1
(43) Pub. Date: Dec. 24, 2015

(54) Wideband Parasitic Capacitance Cancellation for High Speed Switches in Serial Communication

(71) Applicant: Texas Instruments Incorporated, Dallas, TX (US)

(72) Inventor: David Herbert Elwart, II, Sachse, TX (US)

(21) Appl. No.: 14/569,796

(22) Filed: Dec. 15, 2014

Related U.S. Application Data
(60) Provisional application No. 62/013,638, filed on Jun. 18, 2014.

(51) Int. Cl. H04L 25/12; H04L 12/933

(52) U.S. Cl. CPC H04L 25/12; H04L 49/102

(57) ABSTRACT

An apparatus for switching communication signals includes a pair of communication signal paths for carrying a differential serial communication signal. First and second pairs of switches are each respectively connected to the pair of communication signal paths to permit shared access to the pair of communication signal paths. A negative impedance converter (NIC) coupled to the communication signal paths produces negative capacitance to cancel parasitic capacitance associated with the switches. The NIC may be AC-coupled to the communication signal paths, and may employ a bipolar junction transistor (BJT) pair or other active devices.

This application claims the priority under 35 U.S.C. §119(e)(1) of co-pending provisional application Serial No. 62/013,638 filed Jun. 18, 2014 and incorporated herein by reference.

### FIELD

The present work relates generally to switching in serial communication and, more particularly, to compensating for parasitic capacitance associated with passive signal switches used in wideband serial communication.

### BACKGROUND

When passive signal switches are employed in wideband serial communications applications, parasitic capacitance associated with the switches typically should be reduced to maintain signal integrity. With relatively lower speed switches, below about 10 GHz, judicious layout and trade-offs between DC insertion loss and high frequency bandwidth can adequately compensate for (cancel) unacceptable levels of parasitic capacitance to ensure signal integrity. Such techniques are less effective for higher speed (over 10 GHz) switches. Other conventional solutions compensate using some type of “tuned” circuit to resonate parasitic capacitance at a desired frequency. Various tuned circuit solutions use passive matching networks such as series inductors and shunt capacitors, or series capacitors and shunt inductors. Another example of the tuned circuit approach is transmission line matching. Tuned techniques are adequate for applications where only a relatively narrow bandwidth is of interest, but are inadequate for wideband serial communication, where all information from DC up to many times the data rate is relevant for reconstructing the signal.

It is desirable in view of the foregoing to provide compensation for unacceptable levels of parasitic capacitance associated with high speed passive switches used in wideband serial communication applications.

### BRIEF DESCRIPTION OF THE DRAWINGS

FIG. 1 diagrammatically illustrates a communication signal switching apparatus according to example embodiments of the present work.

FIG. 2 diagrammatically illustrates the NIC of FIG. 1 in detail according to example embodiments of the present work.

### DETAILED DESCRIPTION

Example embodiments of the present work use a negative impedance converter (NIC) having bipolar junction transistors (BJTs) that are AC-coupled to a target application (e.g., wideband serial communication). The NIC can compensate for (cancel) parasitic capacitance over a wide frequency range that is proportional to the transconductance (gm) of the BJTs.

In conventional high speed I/O for Serializer/Deserializer (SerDes) applications, active drivers (and/or active receivers) may drive high-speed signals into highly capacitive loads. Besides tuned techniques such as mentioned above, a NIC has been used to cancel parasitic capacitance in such environments. An example of such a NIC is described by Sherif Galal in “10-Gb/s Limiting Amplifier and Laser/Modulator Driver in 0.18-um CMOS Technology”, IEEE JOURNAL OF SOLID-STATE CIRCUITS, VOL. 38, NO. 12, DECEMBER 2003, which is incorporated herein by reference. FIG. 10 of the Galal paper shows a NIC that includes a cross-coupled CMOS transistor pair and produces a negative capacitance to cancel parasitic capacitance in the target circuit. The NIC is DC-coupled to the target circuit, and loads within the target circuit are used to set both the common mode and the differential mode of the NIC. The negative capacitance is effective only at frequencies directly proportional to the transconductance of the CMOS transistor pair. Another example of a conventional NIC is described by Mrkovic et al in “The simple CMOS negative capacitance with improved frequency response”, MIPRO 2012, May 21-25, 2012, which is incorporated herein by reference.

A NIC according to example embodiments of the present work acts as a negative capacitor presented to signal paths where, for example, passive high-speed signal switches operate in a wideband serial communication environment. The negative capacitance is effective to cancel unacceptable levels of parasitic capacitance associated with the signal switches. In some embodiments, the NIC uses a cross-coupled BJT pair, both having a relatively high transition frequency, fₜ . The NIC is AC-coupled to the switches, and passive loads are provided to set the common mode and differential mode of the NIC. The AC coupling ensures that the DC operating points of a transmitter and a receiver at opposite ends of the signal paths are preserved despite the presence of the NIC. This preservation of the operating points of the transmitter and receiver is instrumental in maintaining transparency of the signal switches relative to the overall system.

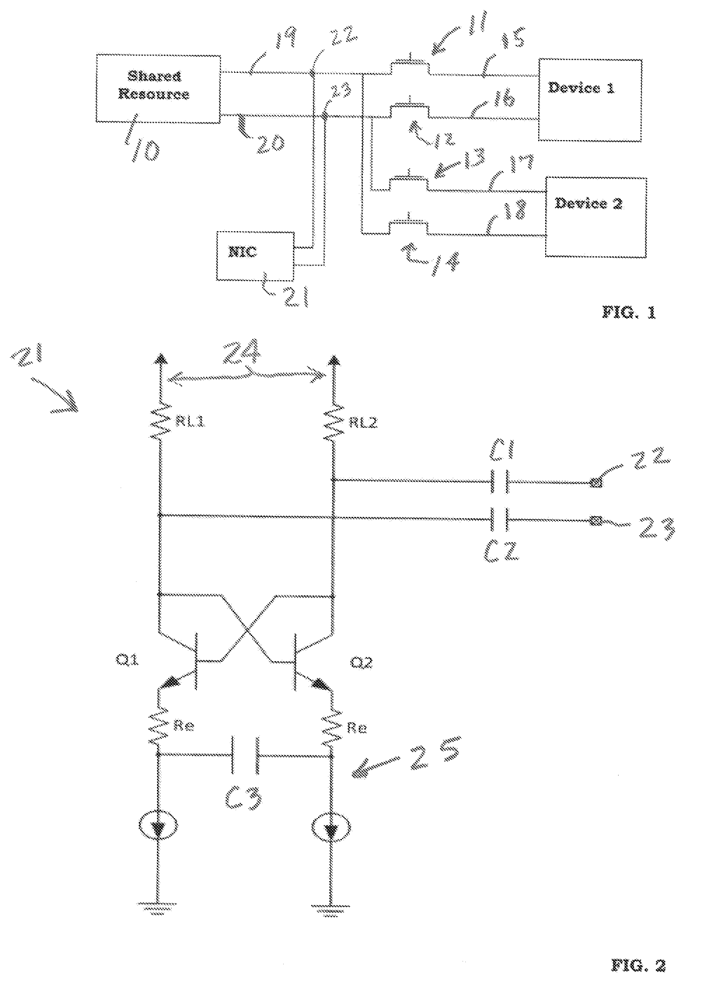

FIG. 1 diagrammatically illustrates a communication signal switching apparatus according to example embodiments of the present work. The passive switches 11-14 typically operate at very high speeds (e.g., above 10 GHz) to selectively connect either device 1 or device 2 to a shared resource 10, and to selectively disconnect either device 1 or device 2 from the shared resource. Device 1 and device 2 engage in wideband serial communication using differential signaling on respectively associated pairs of communication signal paths. Device 1 uses a pair of signal paths 15 and 16, and device 2 uses a pair of signal paths 17 and 18. Switches 11 and 12 interface between the pair 15,16 and a shared pair of communication signal paths 19,20, and switches 13 and 14 interface between the pair 17,18 and the shared pair 19,20. In some embodiments, the switches 11-14 are passive FET switches as shown. In various embodiments, the shared resource 10 is a connector, a cable, etc., such as a USB connector or cable.

Although FIG. 1 shows only two devices sharing the shared resource 10, any number of devices may be interfaced to the shared pair 19,20 by corresponding pairs of passive signal switches. Device 1 and device 2 may be any device that engages in wideband serial communication by differential signaling on a pair of signal paths. Examples include an application processor, a baseband processor in a wireless communication device (e.g., a cell phone), and an HDMI-to-MHL bridge. In various embodiments, the apparatus of FIG. 1 is provided in a wireless communication device (e.g., cell phone), a server application and an enterprise application.

The apparatus of FIG. 1 also includes a NIC 21 coupled to the shared pair 19,20 at nodes 22,23 to provide parasitic capacitance cancellation for the switches 11-14. FIG. 2 diagrammatically illustrates the NIC 21 in detail according to example embodiments of the present work. A pair of cross-coupled BJTs Q1 and Q2 (NPN BJTs in the FIG. 2 example) have their respective collectors AC-coupled to the respective nodes 23 and 22 (see also FIG. 1). The AC-coupling is provided by high pass filters, realized as capacitors C1 and C2 in the FIG. 2 example. The collector of Q1 is connected to the base of Q2, and the collector of Q2 is connected to the base of Q1. The emitters of Q1 and Q2 are coupled to a current source circuit 25 by respective degeneration resistors Re. The resistors Re trade off a small amount of transconductance/bandwidth for less variation across process, voltage and temperature (PVT). Some embodiments omit the resistors Re. The current source circuit 25 includes a pair of current sources with a capacitor C3 connected therebetween, which arrangement is common in the art. The emitters of Q1 and Q2 are respectively coupled to opposite ends of C3. The collectors of Q1 and Q2 are also coupled to a power supply node 24 via respective passive loads, realized as resistors RL1 and RL2 in the FIG. 2 example. The passive loads are used to set the common mode and differential mode of the NIC 21. Some embodiments use a CMOS transistor pair rather than a BJT pair.

Various embodiments of the NIC 21 employ various design parameters that depend on various factors, for example, the process technology, the system data rate and trade offs of gain versus linearity. Such design considerations will be readily apparent to workers in the art.

Although example embodiments of the present work have been described above in detail, this does not limit the scope of the work, which can be practiced in a variety of embodiments.

What is claimed is:

1. An apparatus for switching communication signals, comprising:
a pair of communication signal paths for carrying a differential serial communication signal;
a first pair of switches respectively connected to said pair of communication signal paths to permit shared access to said pair of communication signal paths;
a second pair of switches respectively connected to said pair of communication signal paths to permit shared access to said pair of communication signal paths; and
a negative impedance converter (NIC) AC-coupled to both of said communication signal paths.

2. The apparatus of claim 1, wherein said NIC includes a pair of bipolar junction transistors (BJTs), and wherein each said BJT is AC-coupled to both of said communication signal paths.

3. The apparatus of claim 2, wherein said BJTs have an NPN configuration, and wherein a first of said BJTs has a base AC-coupled to a first of said communication signal paths, and a second of said BJTs has a base AC-coupled to a second of said communication signal paths.

4. The apparatus of claim 3, wherein said first BJT has a collector AC-coupled to said second communication signal path, and said second BJT has a collector AC-coupled to said first communication signal path.

5. The apparatus of claim 2, wherein said BJTs have an NPN configuration, and including a first passive load coupled between a power supply node and a collector of a first of said BJTs, and a second passive load coupled between said power supply node and a collector of a second of said BJTs.

6. The apparatus of claim 5, wherein said first and second passive loads are respective resistors.

7. The apparatus of claim 2, wherein said BJTs have an NPN configuration, and including a first resistor coupled between a current source circuit and an emitter of a first of said BJTs, and a second resistor coupled between said current source circuit and an emitter of a second of said BJTs.

8. The apparatus of claim 1, including first and second high pass filters coupled between said NIC and the respective communication signal paths to provide AC-coupling.

9. The apparatus of claim 8, wherein each of said first and second high pass filters is a capacitor.

10. The apparatus of claim 1, provided in a mobile communication device.

11. An apparatus for switching communication signals, comprising:
a pair of communication signal paths for carrying a differential serial communication signal;
a first pair of switches respectively connected to said pair of communication signal paths to permit shared access to said pair of communication signal paths;
a second pair of switches respectively connected to said pair of communication signal paths to permit shared access to said pair of communication signal paths; and
a negative impedance converter (NIC) including a pair of bipolar junction transistors (BJTs), wherein each said BJT is coupled to both of said communication signal paths.

12. The apparatus of claim 11, including first and second high pass filters, wherein said first high pass filter is coupled between a first of said communication signal paths and said BJTs, and wherein said second high pass filter is coupled between a second of said communication signal paths and said BJTs.

13. The apparatus of claim 12, wherein each of said first and second high pass filters is a capacitor.

14. The apparatus of claim 11, wherein said BJTs have an NPN configuration, and wherein a first of said BJTs has a base coupled to a first of said communication signal paths, and a second of said BJTs has a base coupled to a second of said communication signal paths.

15. The apparatus of claim 14, wherein said first BJT has a collector coupled to said second communication signal path, and said second BJT has a collector coupled to said first communication signal path.

16. The apparatus of claim 11, wherein said BJTs have an NPN configuration, and including a first passive load coupled between a power supply node and a collector of a first of said BJTs, and a second passive load coupled between said power supply node and a collector of a second of said BJTs.

17. The apparatus of claim 16, wherein said first and second passive loads are respective resistors.

18. The apparatus of claim 11, wherein said BJTs have an NPN configuration, and including a first resistor coupled between a current source circuit and an emitter of a first of said BJTs, and a second resistor coupled between said current source circuit and an emitter of a second of said BJTs.

19. The apparatus of claim 11, provided in a mobile communication device.

20. An apparatus for switching communication signals, comprising:
a pair of communication signal paths for carrying a differential serial communication signal;
a first pair of field effect transistor switches respectively connected to said pair of communication signal paths to permit shared access to said pair of communication signal paths;
a second pair of field effect transistor switches respectively connected to said pair of communication signal paths to permit shared access to said pair of communication signal paths;
a pair of NPN bipolar junction transistors (BJTs);
first and second high pass filters;
a power supply node;
a current source circuit; and
first, second, third and fourth resistors;
wherein
a first of said BJTs has a base coupled to said first communication signal path via said first high pass filter, and a second of said BJTs has a base coupled to said second communication signal path via said second high pass filter;
said first BJT has a collector coupled to said second communication signal path via said second high pass filter, and said second BJT has a collector coupled to said first communication signal path via said first high pass filter;
said first resistor is coupled between said power supply node and said collector of said first BJT, and said second resistor is coupled between said power supply node and said collector of said second BJT;
said first BJT has an emitter coupled to said current source circuit via said third resistor, and said second BJT has an emitter coupled to said current source circuit via said fourth resistor; and
each of said first and second high pass filters is a capacitor.
